(19) United States
(12) Patent Application Publication
(10) Pub. No.: US 2003/0132541 A1
(43) Pub. Date: Jul. 17, 2003

(54) Method and device for repairing a tire

(76) Inventor: Dov Zamonski, Glen Rock, NJ (US)

Correspondence Address: Thomas L. Adams, 120 Eagle Rock Avenue, P.O. Box 340, East Hanover, NJ, 07936, US

(21) Appl. No.: 10/047,883

(22) Filed: Jan. 16, 2002

(51) Int. Cl. B29C 73/00

(52) U.S. Cl. 264/36.14; 425/13

(57) ABSTRACT

A repair device can repair a puncture in a normally pressurized vehicle tire. The device has a dispenser with dual barrels containing a pair of separate constituents adapted to form a cement that can adhere to the vehicle tire. A static mixer can be mounted on the dispenser for receiving and mixing the pair of constituents to form the cement. An injection tube mounted on the static mixer is sized to fit into the puncture. A pair of piston heads slidably fitted in the dual barrels can push the pair of constituents through the static mixer to form the cement for injection from outside the tire, through the injection tube, and into the puncture to reach inside the tire. After removing the injection tube, the cement that was injected is allowed to set at least partially before using the tire.

### BACKGROUND OF THE INVENTION

1. Field of the Invention

The present invention relates to apparatus and methods for repairing tire, and in particular, to repairs performed with a cement.

2. Description of Related Art

Repairing flats in tubeless pneumatic tires is usually done in one of two ways. In the one method, the tire is first taken off the rim. The inside surface of the tire is then ground smooth to enable a rubber repair patch to make good contact with the tire's inside surface. Rubber cement is then applied to the area surrounding the puncture and allowed to dry. Thereafter, a specially coated and treated rubber patch is applied and a special tool presses the patch in place, ensuring good contact between opposing surfaces. This method is time-consuming, requires unmounting of the tire, requires technical skills, and the grinding process damages and weakens the tire due to the removal of some support elements. Also, this method fails when the contact between the tire and the patch is inadequate or when the puncture hole is too big.

In the second conventional method, a round rasp is forced through the puncture in the tire in order to enlarge the original hole. A plug is then mounted on a needle hook and is coated with cement before being forced through the enlarged hole. U.S. Pat. No. 5,536,346 gives an example of a tool for inserting a plug into a puncture of a tire. In general, enlarging the puncture in this type of method will weaken and damage the tire. Consequently, the tire is likely to start leaking soon after, requiring a repeat of the repair with additional damage to the tire.

In U.S. Pat. No. 4,279,343 a threaded plug has two cavities filled with a sealant material. The plug is pressed into a tire puncture and threaded into place. Threading wrings the sealant out of the chambers to seal the plug in place. However, few punctures will be suitable for threading, unless the puncture is enlarged, which will again weaken the tire structure.

In FIG. 3 of U.S. Pat. No. 3,190,338 the region of a tire in need of repair is cut out (skived) and clamped on either side. A fluid inlet 34 is used to inject a repair compound into the repair site. The injected material fills the skived region and forms an internal plug. The injected compound is formed by mixing constituents just prior to injection. This apparatus can only function when the damaged area is skived to form a large cavity that is accessible by inlet 34.

In U.S. Pat. No. 4,093,481 a tire is repaired by first filling a damaged area with unvulcanized bonding rubber before covering the area with a flexible cover 3a. Thereafter, a needle pierces the cover 3a to create a vacuum. The needle is not directly inserted into the puncture in the tire. This method is designed to fill a relatively large damaged area and does not teach an effective method for repairing a simple puncture.

In U.S. Pat. No. 4,453,992 a tire is formed with an internal pocket for holding a lubricant. This lubricant will be released from the pocket should the tire deflate, in order to prevent rubber from rubbing on rubber. The lubricant is loaded into the pocket with a syringe that is injected from the inside of the tire. This arrangement requires a relatively complicated tire, which by itself may increase the possibility of tire failure. See also, U.S. Pat. No. 5,070,917 (system for pumping a tire leak sealant into a tire through the valve stem).

It is well known to employ a gun that can inject two-part compounds for various purposes: U.S. Pat. No. 3,439,839 (applying a strip of sealant for installing glass plate in an automobile); U.S. Pat. No. 5,386,928 (materials used in the construction industry or as dental materials); U.S. Pat. No. 5,242,082 (sealing cracks in masonry and around window frames); and U.S. Pat. No. 5,443,181 (material “used in buildings, motor vehicles, ships, aircraft, machines and numerous other apparatus”). For other type of guns for injecting two-part compounds, see U.S. Pat. Nos. 4,986,443; 5,104,005; 5,535,922; and 5,566,860. See also U.S. Pat. No. 4,453,651 (injecting mastic). None of these guns are described as useful for injecting compounds into a tire puncture.

Accordingly, there is a need for a simple and effective method and apparatus for making a long-lasting, high-quality repair.

### SUMMARY OF THE INVENTION

In accordance with the illustrative embodiments demonstrating features and advantages of the present invention, there is provided a method for repairing a puncture in a normally pressurized vehicle tire with cement and an injection tube. The method includes the step of inserting the injection tube from outside the tire into the puncture. Another step is pushing the cement through the injection tube and the puncture to reach inside the tire. The method includes the step of removing the injection tube, and allowing the cement that was injected to set at least partially before using the tire

In accordance with another aspect of the invention there is provided, a repair device for repairing a puncture in a normally pressurized vehicle tire. The device has a dispenser containing a cement adapted to adhere to the vehicle tire. Also included is an injection tube adapted to be mounted on the dispenser and sized to fit into the puncture without reaching inside the vehicle tire. The device also has a plunger slidably fitted in the dispenser for pushing the cement through the injection tube and through the puncture

In accordance with yet another aspect of the invention there is provided, a repair device for repairing a puncture in a normally pressurized vehicle tire. The device has a dispenser with dual barrels containing a pair of separate constituents adapted to form a cement that can adhere to the vehicle tire. Also included is a static mixer adapted to be mounted on the dispenser for receiving and mixing the pair of constituents to form the cement. The device also includes an injection tube mounted on the static mixer and sized to fit into the puncture. Also included is a pair of piston heads slidably fitted in the dual barrel for pushing the pair of constituents through the static mixer to form the cement for injection through the injection tube and into the puncture.

By employing apparatus and methods of the foregoing type, an improved tire repair will be achieved. In a preferred embodiment, a syringe-like device has two barrels filled with separate constituents. These constituents can be pressed out of the barrel to flow through a static mixer and form a cement. This cement is then pushed through an injection tube, which is inserted into a tire puncture from the outside, preferably, to a depth that reaches into but not through the tire.

The cement pushed through the injection tube flows through the tire puncture and eventually to the inside of the tire to form a flared head. As the injection tube is then withdrawn, the cement is still pushed through the tube in order to fill any voids in the regions just vacated by the injection tube.

In some embodiments the cement is pushed by a manually operated plunger. In some cases the device can be sized to dispense cement for a single puncture, and will thereafter be disposed in its entirety. In other embodiments the device can repeatedly dispense cement into successive punctures, in which case just the static mixer and the injection tube are disposable. After disposal of the mixer and injection tube, a cap can be placed over the dispensing end of the barrels that contain the cement-forming constituents.

For repair centers, larger barrels containing the two cement-forming constituents can be mounted on a handle having a trigger-operated ratchet mechanism for deploying a pair of plungers in order to dispense the cement. This mechanism can be used to rapidly inject cement into successive punctures.

### BRIEF DESCRIPTION OF THE DRAWINGS

The above brief description as well as other objects, features and advantages of the present invention will be more fully appreciated by reference to the following detailed description of presently preferred but nonetheless illustrative embodiments in accordance with the present invention when taken in conjunction with the accompanying drawings, wherein:

FIG. 1 is a side view of a dispenser, partly in section, in accordance with principles of the present invention;

FIG. 2 is a longitudinal sectional view of a portion of the dispenser of FIG. 1;

FIG. 3 is an exploded, perspective view of the distal end of the dispenser of FIG. 1, showing a cap used to cover the barrel when the static mixer and injection tube are not installed;

FIG. 4 is a perspective view showing the dispenser of FIG. 1 being used to perform a method in accordance with principles of the present invention;

FIGS. 5A-5B show successive steps for the method of FIG. 4;

FIG. 6 is a detailed perspective view of a portion of an injection tube that is an alternative to that shown in FIG. 1;

FIG. 7 is a side elevational view, partly in section, of a handle that can be used to dispense cement from a barrel similar to that shown in FIG. 1; and

FIG. 8 is an end view of the face of the receptacle of the handle of FIG. 7, which is adapted to hold a barrel similar to that shown in FIG. 1.

### DETAILED DESCRIPTION OF THE PREFERRED EMBODIMENTS

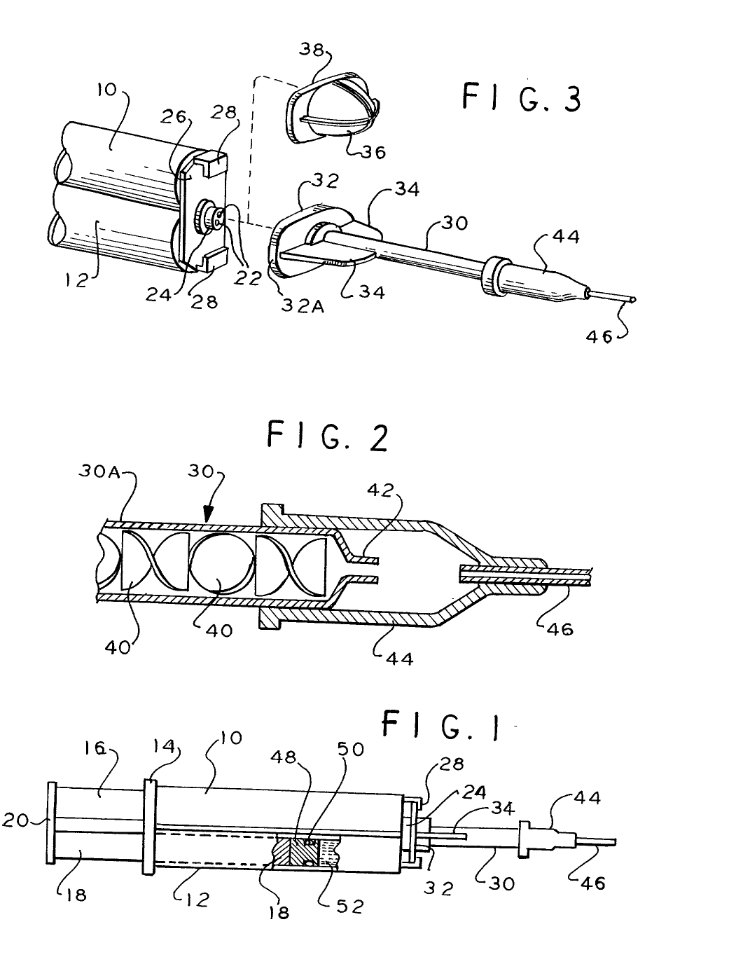

Referring to FIGS. 1-3, the illustrated dispenser is shown with dual barrels 10 and 12, which are molded, hollow plastic cylinders connected together by integral flange 14 at their proximal ends (in this view, the left end). The barrels 10 and 12 are about 3.0 inches (7.6 cm) long and have an inside diameter of about 0.44 inch (1.14 cm), although different dimensions may be employed depending upon the desired capacity of the barrels. Fitted into the barrels' open proximal ends is a plunger in the form of a parallel pair of closed plastic cylinders 16 and 18, which are joined together at their proximal ends by an integral flange 20. While the foregoing components are made of plastic, in other embodiments they may be made of metal, ceramic, or other suitable materials.

The distal ends of barrels 10 and 12 feed into the two outlet ports 22 formed in cylindrical hub 24. Hub 24 is integral with platform 26 whose outer ends are fitted with overhanging, L-shaped brackets 28.

The proximal end of static mixer 30 has an oval flange 32 designed to fit under brackets 28. Mixer 30 can be installed by bringing it against hub 24 in the orientation shown in FIG. 3. Once in place, wings 34 can be used to manually rotate mixer 30 through 90° to bring the extended portions 32A of flange 32 under brackets 28. Alternatively, cap 36 can be installed on hub 24 by rotating the flange 38 under brackets 28. The flange 38 has the same outline and shape as previously mentioned flange 32. Cap 36 is shown as a dome-like structure with reinforcing ribs integrally mounted atop flange 38.

The main body of mixer 30 is shown as a tubular housing 30A containing a plurality of coaxial blades 40 each having a helical twist of 180°. A phase shift of 90° occurs at the transition between each of the blades 40 (that is, from preceding to succeeding blades 40). Accordingly, fluid flowing around either side of one of the blades 40 will be swirled 180° and then split into two different paths at the transition to the succeeding blade. In a preferred embodiment there will be twelve such blades so that the flow patterns will be divided and swirled twelve times; although a different number of blades may be employed in other embodiments. Also in this preferred embodiment, the twelve blades 40 will be molded as a single integral piece.

The distal end of housing 30A narrows down at neck 42 and is fitted with a plastic sleeve 44 whose narrow distal end is sealed around steel injection tube 46. Tube 46 extends from sleeve 44 about ¼ inch (0.6 cm), and has an outside diameter of about 0.04 inch (1.0 mm) and an inside diameter of about 0.03 inch (0.75 mm); although these dimensions can vary depending upon the size of the puncture and the desired depth of penetration into the puncture. Preferably, the injection tube 46 penetrates about half way into the tire, up to but not past any steel belted radial. This depth of penetration is typically ¼ inch (0.6 cm) and it is therefore advantageous (but not mandatory) to limit the exposed length of the injection tube to this desired penetration depth.

Plunger cylinder 18 is shown bearing against piston head 48 inside barrel 12. It will be appreciated that a similar piston head (not shown) abuts plunger 16 inside barrel 10. Piston head 48 is a short plastic cylinder with an annular groove containing an O-ring 50. Thus arranged, the portions of barrels 10 and 12 on the distal (downstream) side of the piston head forms sealed chambers separately containing complementary constituents 52 that when mixed form a curable cement that acts as a sealant composition.

The sealant composition for use in the present invention generally comprises two or more components that upon contact with one another polymerize together, and wherein either (a) at least one of the components alone or (b) the polymerization product or(c) both adheres to synthetic rubber as may be found in a vehicle tire. Preferably, the co-reactive components are monomers which are co-reactive with each other in the absence of an initiator. Notwithstanding the forgoing, one component may be a monomer and the other component contain an initiator for the polymerization of the first component. Either component may contain suitable carrier materials which would be well known in the art.

More preferably, the composition comprises (a) a first component comprising a monomer having at least two functional groups, which functional groups are the same or if different are not reactive with each other; and (b) a second component comprising a monomer having at least two functional groups which are the same or if different are not reactive with each other. The functional groups of the monomer of component (a) are reactive with the functional groups of the monomer of component (b). Each of components (a) and (b) may be made up of mixtures of monomers as long as these limitations on the reactivity of the functional groups is adhered to.

In a preferred embodiment, the monomers of the component (a) are diisocyanates, and the component (b) monomer is a di- or poly-ol, so that the polymerization product is a polyurethane. A preferable diisocyanate is alkylenedi(phenylisocyanate), most preferably is 4,4′-methylene-bis(phenylisocyanate). Component (b) may also contain a diamine, which reacts with the diisocyanate to form a polyurea compound. In a preferred embodiment, component (b) is a blend of (I) a di- or poly-ol and (II) a diamine, which upon reaction with the diisocyanate, results in generally a blend of polyurea and polyurethane with some mixed poly urea/urethane.

In one preferred embodiment the monomers that can be used are commercially available from Smooth-On of Easton, Pa. under the name Ure-Bond. This product has both monomers needed for the polyurethane formation contained in separate compartments for admixture during the application process.

In using the invention for the repair of synthetic rubber automotive tires, the Ure-Bond components may not be as convenient as might be desired. For example, the components would be more easily applied to a puncture without removal of the tire if the viscosity were increased. This would prevent the internal pressure from expelling the components before they had a chance to react suitably. This can be readily accomplished by reducing the solvent content of one or both components, adding a suitable viscosity enhancing agent, and other techniques well known in the art.

Two methods of increasing the viscosity of the material are (i) the inclusion of a small amount of a diamine in the di- or poly-ol containing component and (ii) addition of 1-5 wt % fumed silica to the hydroxy free component (b). In varient (i), upon mixture of the diamine containing diol component with the isocyanate component, the diamine component immediately reacts with some of the 4,4′-methylene bis(phenylisocyanate) thereby rapidly increasing the viscosity. The diamines are monomeric aromatic diamines, typically selected (a) phenyl and naphthyl diamines which are unsubstituted or may be sunbstituted on the aromatic rings with one or more lower alkyl groups and (b) diamino (di(aryl) methylene) wherein the aryl groups are the same or different and selected from phenyl and naphthyl, each of which is unsubstited or substituted with one or more lower alkyl groups, the two amino groups being on any free position, but preferably one on each of the aryl groups. Preferred diamines include toluene diamine, methylene dianiline, and diethyltoluene diamine.

When silica is added to increase the viscosity, it is generally used in amounts of about 1 to about 5% in the diol containing component. Fumed silica is preferable and of the fumed silicas, Cabosil 720 or Cabosil M-5 (both commercially available) are most preferred.

Also, the cure time of the Ure-Bond product as marketed, while suitable for many applications, is not as short as would be most desirable. The cure time of that product is in the order of 15-30 minutes. It would be preferable to have the cure time shortened to 3-5 minutes or less. This can be readily accomplished by including suitable polymerization accelerators which are well known in the art. Suitable examples include organometallic materials such as dibutyltin dilaurate, tetrabutyl titanate and stannous octoate; amines such as tetramethylethylenediamine, triethylenediamine, or 33% triethylenediamine in propylene glycol; acids such as adipic acid, azelaic acid, stearic acid, ethylhexanoic acid, isophthalic acid, and terphthalic acid, among others.

Furthermore, the Ure-Bond product results in a polyurethane which, while suitable, is more rigid than would be optimum for automotive tires, which in use, result in significant flexing of the tire walls. Increasing the flexibility of the polymer would therefore be advantageous. This is readily accomplished by inclusion of suitable plasticizers. Such plasticizers include, for example, phthalate diesters, benzoate diesters, isobutyrate diesters, or adipate diesters among others. Alternatively, the flexibility of the polymerization product can be increased by increasing the molecular weight of the oligomeric diamine in the non-isocyanate component. However, if this route is taken, the molecular weight of the diisocyanate monomer component must also be increased to match, which can be accomplished by making the diisocyante component in the from of a pre-polymer. Such techniques are well known in the art.

In addition to the “formulation” type of modifications mentioned above to optimize the properties of the components (a) and/or (b) and/or the polymerization product, one can modify properties of the monomers themselves, such as by chain extension or shortening between the reactive functional groups, modify the molecule in the region between the functional groups by adding side chains which may or may not include additional functional groups which do not adversely affect the monomers, the polymer, or the polymerization reaction.

A modified version of the Ure-Bond product which is particularly adapted to optimize each of these features and therefore is the most preferred version, is available from Smooth-On of Easton, Pa. under the company designation 79-88-2. In this version, the isocyanate containing component is formulated to be used in a 1:1 ratio with the diisocyanate free component. The resulting viscosity of the diisocyanate containing component is about 40-about 70 cps, preferably about 60 cps. The diisocyanante free component has a viscosity of about 5000-about 5100 cps, preferably about 5040 cps. The cured material from this reaction of these two components has a Shore A hardness of about 80-about 90, preferably about 85.

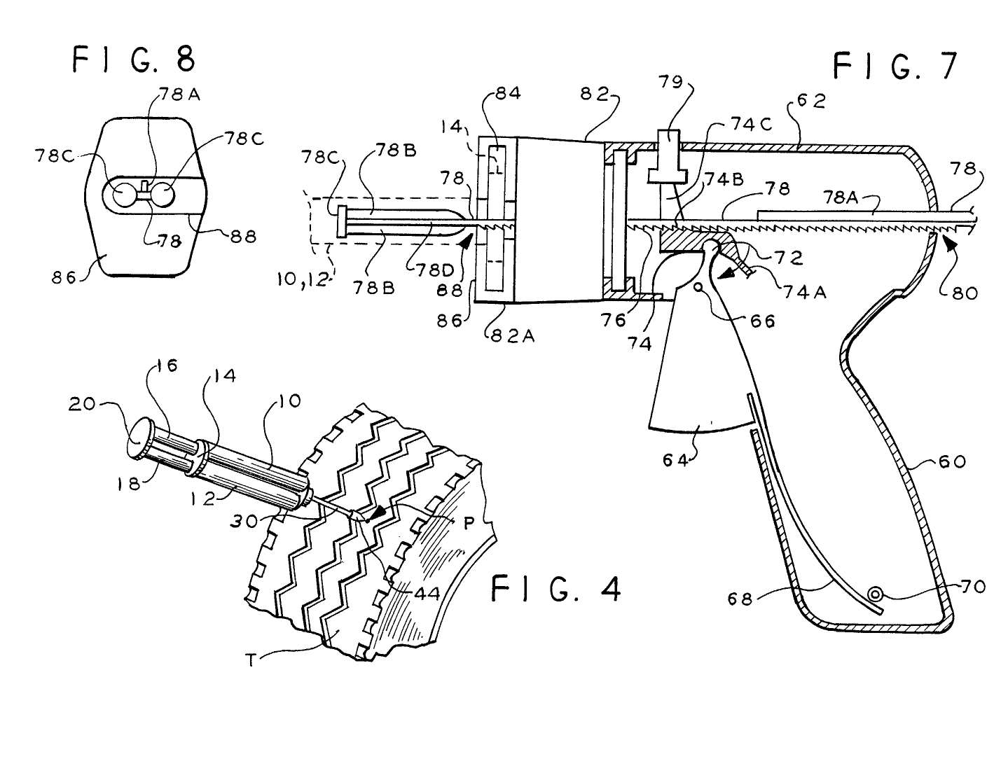

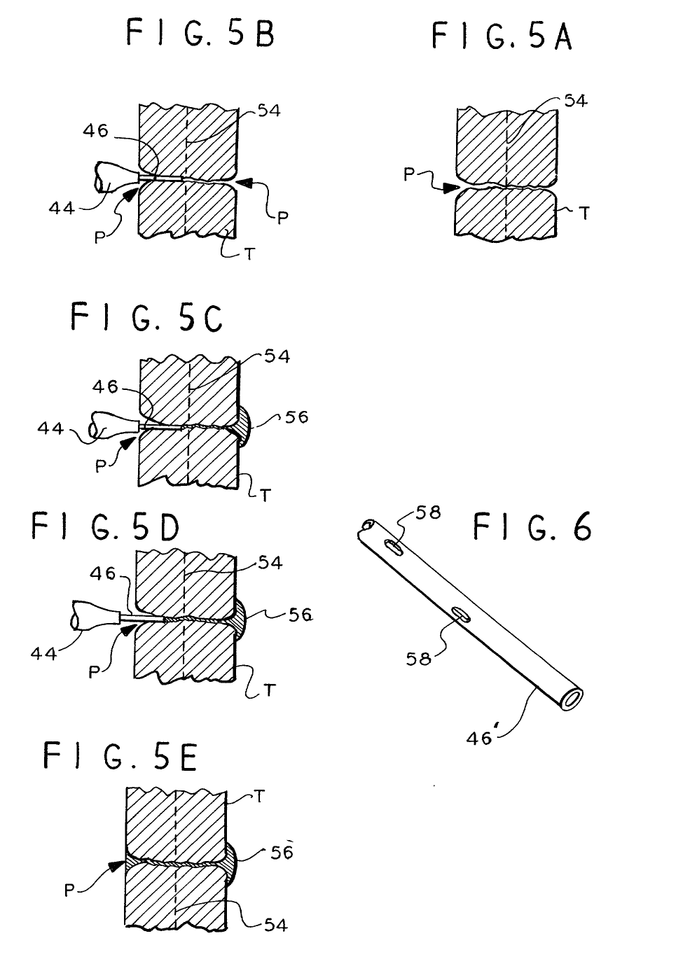

To facilitate an understanding of the principles associated with the foregoing embodiment of FIGS. 1-3, its operation will be briefly described in connection with the diagrams of FIGS. 4 and 5A-5E. The dispenser is normally supplied with cap 36 installed between the brackets 28 (FIG. 3). Cap 36 is removed after turning it 90° so that flange 38 clears brackets 28. Cap 38 may contain a rotating plug (not shown) with two prongs that fit into the ports 22 of hub 24.

Next, static mixer 30 may be attached by placing flange 32 over hub 24 and rotating the mixer so that extended portions 32A of the flange 32 will be locked under brackets 28. In some embodiments mixer 30 will not be supplied with an injection tube and in such cases sleeve 44 may now be slipped over housing 30A of static mixer 30 to install injection tube 46. In other embodiments an injection tube may be sealed directly onto the distal end of the housing 30A of the static mixer.

Barrels 10 and 12 will be pre-filled with cement-forming constituents 52, although in some embodiments, the user may have a separate supply of such constituents and may manually fill and refill the barrels 10 and 12. In some cases, the user will separately mix these constituents and fill them into a dispenser having a single barrel, although this single barrel will be of limited utility since it must be discarded once the cement cures.

FIG. 5A shows a tire T with a puncture P extending from the outside to the inside of the tire. The walls of the puncture P are shown to be uneven, but in some cases may be smooth and may have portions that are occluded. A steel belt 54 is shown embedded about midway through the thickness of the tire T, as is typically the case in steel belted radial tires.

The dispenser will now be thrust from the outside, so that its injection tube 46 penetrates into puncture P of tire T (FIGS. 4 and 5B). Injection tube 46 is shown penetrating about halfway into tire T, reaching a position just to the outside of the steel belt 54. Tube 46 may be inserted more deeply, but not so deeply as to cause cement to simply run into the inside of the tire T without beneficial effect. Tube 46 may be inserted less deeply, but not so shallowly as to cause a high back pressure that impedes injection of cement.

The user will now depress flange 20 to drive plungers 16 and 18 into barrels 10 and 12, respectively. In response, pistons 48 will be driven inwardly through the two barrels 10 and 12 to push their respective constituents 52 through ports 22 and into static mixer 30.

Inside static mixer 30 the two constituents 52 will each be divided in half (four distinct flow paths) and each half will be mixed with a half from the other complementary constituent before being swirled 180° by one of the helical blades 40. The two flow paths around this blade 40 reach the next blade and are each divided in half again, with each half from one side of the preceding blade being mixed with a half from the opposite side of the preceding blade. These two new mixed flow paths are again swirled 180°. In the preferred embodiment the flow paths are divided and swirled twelve times, which will be adequate to thoroughly mix the two constituent components 52 to form a cement.

The cement is injected from tube 46 into puncture P as shown in FIG. 5C. Specifically, cement is driven through puncture P and reaches the inside of tire T. Cement accumulates on the inside of tire T to form the flared head 56. After this initial injection, injection tube 46 is gradually withdrawn while pressure is still applied to the plungers 16 and 18. Consequently, additional cement fills any voids remaining in the regions of puncture P vacated by injection tube 46, as shown in FIG. 5D. In some embodiments, the filling of the voids can be enhanced by employing an injection tube 46′ as shown in FIG. 6. This injection tube 46′ has a number of side vents 58, which allow lateral injection of cement into such voids.

Eventually, injection tube 46 is completely withdrawn and the puncture P is completely filled with cement as shown in FIG. 5E. A typical injection of cement will be about 0.33 to 0.50 cc, although this volume will vary depending upon the size of the puncture, the thickness of the tire T, the size of the flared head 56, etc. The cement in puncture P now cures in about one to three minutes forming an elastomeric seal of polyurethane that adheres to the surfaces of tire T. Tire T can now be inflated. Flared head 56 will be pressed against the inside surface of tire T. The polyurethane used forms a good chemical bond with synthetic and non-synthetic rubber. The flared head 56 inside the tire T gives added security.

The cement in puncture P is now ready for use and tire T can be driven in an ordinary fashion. The cement will be sufficiently flexible and durable to withstand the conditions existing during ordinary use. Significantly, tire T need never be removed from its supporting rim and, in fact, may be repaired while still mounted on a vehicle.

Referring to FIGS. 7 and 8, a hollow handle is shown with a grip 60 integral with a cylindrical case 62. Trigger 64 is pivotally mounted on pin 66 to swing in and out of grip 60. Trigger 64 has an integral leaf spring 68 that bears against stud 70 and tends to drive trigger 64 outwardly, that is, to the position shown. Trigger 64 has on its upper end a knuckle 72 that pivotally supports pawl 74. An integral leaf spring 74A on pawl 74 tends to rotate it (clockwise in FIG. 7). The upper surface of pawl 74 has a number of ratchet teeth 74B that engage teeth 76 of rack 78. Pawl 74 has a pair of tines 74C (one shown in this view) straddling either side of rack 78. A pushbutton 79 extending through the top of case 62 can be depressed to depress tines 74C, thereby disengaging pawl teeth 74B from rack teeth 76.

Rack 78 is a plastic blade slidably mounted inside case 62 and extending through rear opening 80 to the outside of case 62. Rack 78 also extends through collar 82 and can be slid to extend past collar 82 as shown in FIG. 7. The distal end of rack 78 is bifurcated into two tines 78D supporting two circular plunger heads 78C. Tines 78D each have a pair of reinforcing ribs 78B, giving this section of the rack 78 a cruciform cross-section. Rack 78 also has an upright reinforcing rib 78A running along part of its length.

Collar 82 has a hollow distal section 82A with a slot 84 giving section 82A a double-walled configuration. The front wall 86 of section 82A has a slot 88, giving wall 86 a C-shaped configuration. Accordingly, a dispenser such as that shown in FIG. 1 (perhaps slightly larger), but with the plungers 16 and 18 removed, can be installed in slot 84 by placing the flange 14 into the slot, allowing barrels 10 and 12 to extend outwardly as shown in phantom in FIG. 7.

Of course, to install barrels 10 and 12, rack 78 must be fully retracted. Such retraction can be accomplished by depressing pushbutton 79 to lower pawl teeth 74B. Complete retraction can then be accomplished by grasping and pulling the section of rack 78 that extends through rear opening 80. The flange 14 may then be centered inside slot 84 so that the barrels 10 and 12 will be aligned with the plunger heads 78C.

The user can then insert the injection tube associated with barrels 10 and 12 into a tire, much as shown in FIG. 4. Plungers 78 can be manually pushed until it engages the piston heads 48, where the plungers will stop. Next, the user will depress trigger 64, causing pawl teeth 74B to be driven forward, to extend plunger heads 78C through barrels 10 and 12. When trigger 64 is released, leaf spring 68 drives the trigger outwardly and retracts pawl 74. Teeth 74B will now skip or ratchet over rack teeth 76 without moving rack 78. As trigger 64 is repeatedly depressed, plunger heads 78C will move the piston heads, such as piston heads 48 shown in FIG. 1. Consequently, barrels 10 and 12 will be operated in a manner similar to that previously described in connection with FIG. 1 in order to repair a tire as before.

The foregoing embodiment is intended for a commercial service center where the handle of FIG. 7 will be used repeatedly for many tires during the course of the day. During idle times when the handle is not in use, any static mixer and injection tube associated with the handle can be discarded, and the barrels ends can be closed with a cap similar to that shown in FIG. 3.

It is appreciated that various modifications may be implemented with respect to the above described, preferred embodiments. In some embodiments the injection tube may be relatively long and have insertion depth markers that are used to visually control the insertion depth, allowing the user to take into account the type of tire being repaired. Also, the static mixer can be attached to the barrels with a variety of quick-disconnect couplers; or may be permanently attached to the barrels in some embodiments. In other embodiments the user may be provided a kit having a variety of barrels, mixers, and injection tubes that may be assembled in various combinations depending upon the desired capacity, insertion depth, the properties of the cement constituents, etc. In still other embodiments the cement may be formed from a single constituent that cures by drying, by the application of heat, etc. Moreover, instead of manually ejecting cement, in some embodiments gas may be released from a pressurized container to eject the cement. Alternatively, the cement may be dispensed by squeezing a pliable container. In addition, the materials used for the various components may be made of plastics, metals, ceramics, composite materials or other materials, depending upon the desired strength, weight, temperature stability, immunity to corrosion, etc.

Obviously, many modifications and variations of the present invention are possible in light of the above teachings. It is therefore to be understood that within the scope of the appended claims, the invention may be practiced otherwise than as specifically described.

1. A method for repairing a puncture in a normally pressurized vehicle tire with cement and an injection tube, comprising the steps of:
inserting said injection tube from outside said tire into the puncture;
pushing said cement through said injection tube and said puncture to reach inside said tire;
removing said injection tube; and
allowing the cement that was injected to set at least partially before using said tire.

2. A method according to claim 1 wherein the step of inserting the injection tube from outside said tire into the puncture is performed without the injection tube reaching inside said tire.

3. A method according to claim 1 wherein the step of pushing the cement is performed sufficiently to form inside said tire a flared head that is substantially wider than the puncture.

4. A method according to claim 1 wherein the step of removing said injection tube is performed while cement is being pushed through said tube in order to fill with cement portions of said puncture vacated by said tube.

5. A method according to claim 1 employing complementary constituents and a static mixer, and comprising the step of:
mixing the complementary constituents with said static mixer to form the cement just as the cement is being pushed into said tube and said puncture.

6. A method according to claim 5 comprising the step of:
discarding the injection tube and the static mixer after the injection tube is removed from said tire.

7. A method according to claim 5 employing a dispenser with dual barrels containing said complementary constituents, and comprising the step of:
pushing only some of the constituents in the barrels through said injection tube into the puncture in order to allow repeated use of the barrels; and
replacing the injection tube and static mixer each time after the injection tube is removed from said tire.

8. A repair device for repairing a puncture in a normally pressurized vehicle tire, comprising:
a dispenser containing a cement adapted to adhere to said vehicle tire;
an injection tube adapted to be mounted on said dispenser and sized to fit into the puncture without reaching inside said vehicle tire;
a plunger slidably fitted in said dispenser for pushing said cement through said injection tube and through said puncture.

9. A repair device according to claim 8 comprising:
a cap secured on said dispenser and being removable to allow mounting of said injection tube on said barrel.

10. A repair device for repairing a puncture in a normally pressurized vehicle tire, comprising:
a dispenser with dual barrels containing a pair of separate constituents adapted to form a cement that can adhere to said vehicle tire;
a static mixer adapted to be mounted on said dispenser for receiving and mixing said pair of constituents to form said cement;
an injection tube mounted on said static mixer and sized to fit into the puncture; and
a pair of piston heads slidably fitted in said dual barrel for pushing said pair of constituents through said static mixer to form the cement for injection through said injection tube and into said puncture.

11. A repair device according to claim 10 wherein said static mixer is removably attached to said dispenser for replacement after depression of said piston heads.

12. A repair device according to claim 10 comprising:
a cap secured on said dispenser and being removable to allow mounting of said injection tube on said dispenser.

13. A repair device according to claim 10 wherein said static mixer comprises a plurality of blades with a helical twist.

14. A repair device according to claim 10 wherein said static mixer comprises an end to end plurality of coaxial blades each with a helical twist of a predetermined angle, a phase shift of 90° existing at transitions between a preceding one to a succeeding one of the coaxial blades.

15. A repair device according to claim 14 wherein said static mixer includes a tubular housing containing said coaxial blades, said tubular housing having a distal end supporting said injection tube, and a proximal end adapted to be removably secured to said dispenser.

16. A repair device according to claim 10 wherein said dispenser comprises:
a handle with a reciprocatable trigger, said dual barrel being adapted to be removably attached to said handle;
a ratchet mechanism coupled to said trigger for pushing said piston heads into said dual barrel in response to reciprocation of said trigger.

17. A repair device according to claim 10 wherein said cement is curable and has a pre-cure viscosity sufficiently high to prevent expulsion of said cement by pressure in said tire before curing of said cement.

18. A repair device according to claim 17 wherein said cement cures in less than five minutes.

19. A repair device according to claim 17 wherein said pair of constituents form said cement, which cures into a polyurethane.

20. A repair device according to claim 10 wherein said injection tube has at least one side vent.
